(19) United States
(12) Patent Application Publication
(10) Pub. No.: US 2015/0198799 A1
(43) Pub. Date: Jul. 16, 2015

(54) TELESCOPE WITH PRISM REVERSING SYSTEM

(71) Applicant: SWAROVSKI-OPTIK KG., Absam (AT)

(72) Inventors: Ludwig Pernstich, Rum (AT); Patrick Kurz, Zirl (AT); Thomas Salzburger, Innsbruck (AT); Sebastian Wachsmuth, Innsbruck (AT)

(73) Assignee: SWAROVSKI-OPTIK KG., Absam (AT)

(21) Appl. No.: 14/595,403

(22) Filed: Jan. 13, 2015

(30) Foreign Application Priority Data
Jan. 13, 2014 (AT) A 50021/2014

(51) Int. Cl. G02B 23/04; G02B 27/34

(52) U.S. Cl. CPC G02B 23/04; G02B 27/34; G02B 25/001

(57) ABSTRACT

Tie invention relates to a telescope (1) comprising an objective lens (2), an eye-piece (3) and a prism reversing system (4) and having projection optics (21) with an optical path for reproducing an image of a reticle in a focal plane of the eye-piece (3), the optical path of the projection optics (21) being coupled into the observation beam path by means of a beam splitter, and the projection optics (21) comprise a mask (22) and a light source (23) disposed so as to illuminate the mask (22) from behind.

The invention relates to a terrestrial telescope with a prism reversing system of the type outlined in the introductory part of claim 1.

Telescopes, which in addition to enabling pure observation of distant objects also enable angles or distances within the space around the objects to be measured, are provided with graticules or reticles for this purpose, which are disposed in the intermediate image plane of the optical path. The lines of the reticle and the image of the distant objects generated by the objective lens with the latter superimposed on it can be sharply observed through the eye-piece of the telescope. By using reticles with a corresponding scaling of the spacing between the lines to observe objects of a known size, it is possible to measure or at least estimate their distance. To enable the use of such telescopes under poor light conditions or poor ambient conditions, the reticle may also be provided with illumination to increase contrast. For example, document EP 1 653 271 B1 describes a telescopic sight with a reticle or a crosshair in which the reticle can be illuminated by a laterally disposed light source. Reticles which are disposed directly in the path of rays of the observation beam path have proved to be ineffective because particles of dust adhering to the reticle surface can create scattered light and can therefore impair the image quality. Furthermore, such reticles are always visible in the observation beam path.

The objective of the invention is to propose a telescope with a reticle with improved image quality and of a compact design.

This objective is achieved by means of a telescope having an objective lens, an eyepiece and a prism reversing system, which prism reversing system is disposed in the observation beam path extending between the objective lens and the eyepiece, and the telescope has projection optics with an optical path for reproducing an image of a reticle in a focal plane of the eyepiece. The optical path of the projection optics is coupled into the observation beam path by means of a beam splitter. The projection optics of the telescope proposed by the invention comprise a mask and a light source, and the light source is disposed so as to illuminate the mask from behind. The mask is advantageously provided in the form of a plane-parallel glass plate with an opaque coating, and the glass plate has transparent regions in the form of a negative of a pattern of a reticle (line image). The advantage of this is that a line image can be created in which the lines or lines and nets of lines are self-illuminating.

Also of advantage is another embodiment of the telescope in which the optical path of the projection optics has a first main beam portion and a second main beam portion and these are connected to one another by means of a deflecting prism, and the first main beam portion and the second main beam portion are oriented perpendicular to the optical axis of the objective lens. The advantage of this design of the optical path of the projection optics is that it results in a more compact design of the projection optics because the volume thereof can be limited to a circular disc around the optical axis of the objective lens, as it were. This is of advantage because the telescope can be more easily made in a modular structure comprising an objective part, an eyepiece part and a middle part lying in between incorporating the projection optics and prism reversing system.

Based on another advantageous embodiment of the telescope, the beam splitter is disposed in a transition region between a coupling prism of the projection optics and the prism reversing system of the observation beam path. In this connection, the coupling prism is cemented to a deflecting prism of the prism reversing system in particular and a partially transparent coating is provided on a boundary surface between the coupling prism and the deflecting prism of the prism reversing system. The advantage of this is that it enables an even more compact design of the unit comprising the prism reversing system and projection optics to be obtained.

Based on another embodiment of the telescope, the projection optics comprise a focusing device by means of which the position of the image plane of the reproduced line image (pattern of the reticle of the mask) can be shifted relative to the position of the image plane of the objective lens or the position of the focal plane of the eyepiece, the advantage of which is that a Parallax compensation or a diopter compensation can be obtained.

The advantage of another embodiment of the telescope which is provided with a control button for switching the light source on and off and regulating the brightness is that a switch can be made between different types of usage of the telescope—for measuring operations or for pure observation. The image of the pattern of the reticle or mask can also be adapted to different ambient light conditions.

A particularly advantageous design of the prism reversing system is one based on a Porro prism system. It comprises a first and a second deflecting prism, and the observation beam path is deflected by the first deflecting prism from a first main beam portion into a second main beam portion and from the second main beam portion into a third main beam portion. The observation beam path is deflected by the second deflecting prism from the third main beam portion into the fourth main beam portion and from the fourth main beam portion into a fifth main beam portion. This multiple deflection (“folding”) of the observation beam path advantageously results in a significantly shorter overall length of the telescope.

Also of advantage is the fact that the coupling prism is disposed on a first reflection surface of the second deflecting prism, and the second main beam portion of the optical path of the projection optics is oriented coaxially with the fourth main beam portion of the observation beam path running through the second main deflecting prism.

Also of advantage is an alternative embodiment in which the coupling prism is disposed on a first reflection surface of the first deflecting prism, and the second main beam portion of the optical path of the projection optics is oriented coaxially with the second main beam portion of the observation optical path running through the first deflecting prism.

Also of advantage is another embodiment of the telescope in which a focusing device is disposed in the observation beam path between the objective lens and prism reversing system.

Based on another embodiment of the telescope, the eyepiece has a zoom lens system, the advantage of which is that the overall zoom factor of the telescope can be adjusted across a predefined range. Another advantage of providing the zoom lens system in the eyepiece is that if the zoom setting is changed, the line image of the reticle or mask is changed as well in the same way as the image of the distant objects.

To provide a clearer understanding, the invention will be described in more detail below with reference to the appended drawings.

These are highly simplified, schematic diagrams illustrating the following:

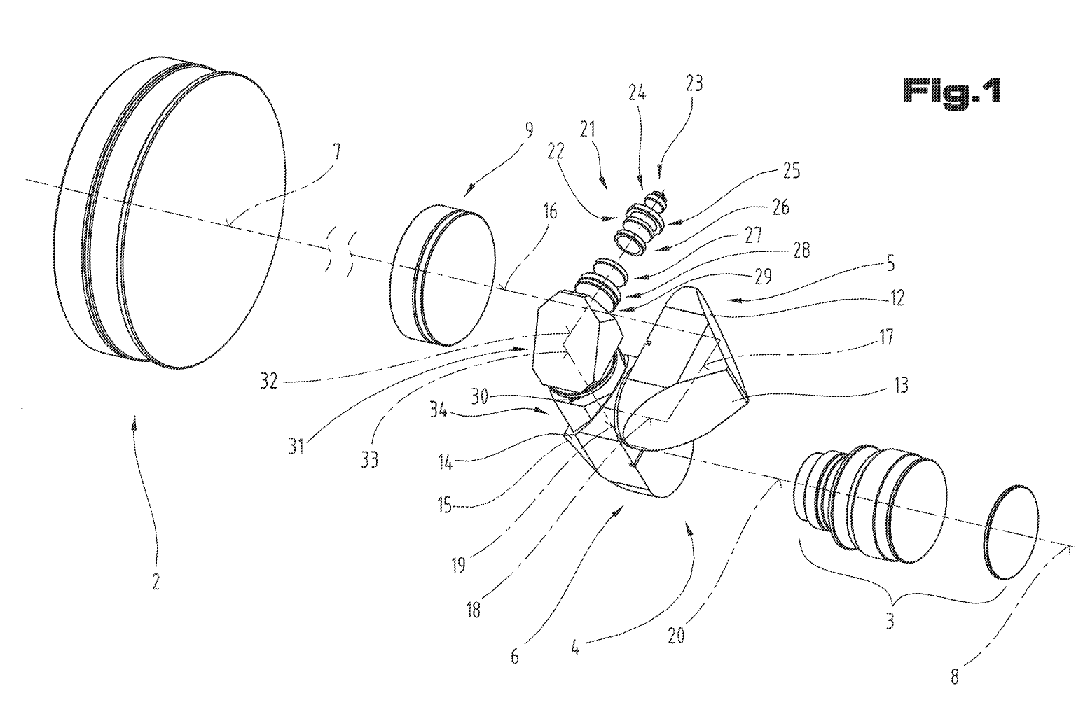

FIG. 1 the optical system of a telescope proposed by the invention;

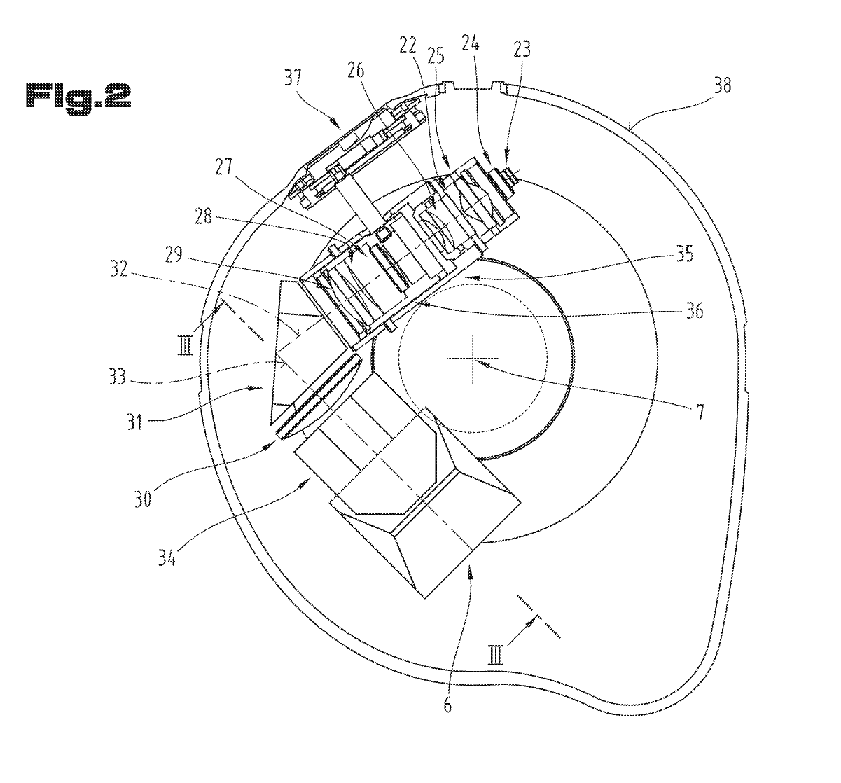

FIG. 2 a cross-section of the telescope with a viewing direction parallel with the optical axis of the objective lens with details of the projection optics;

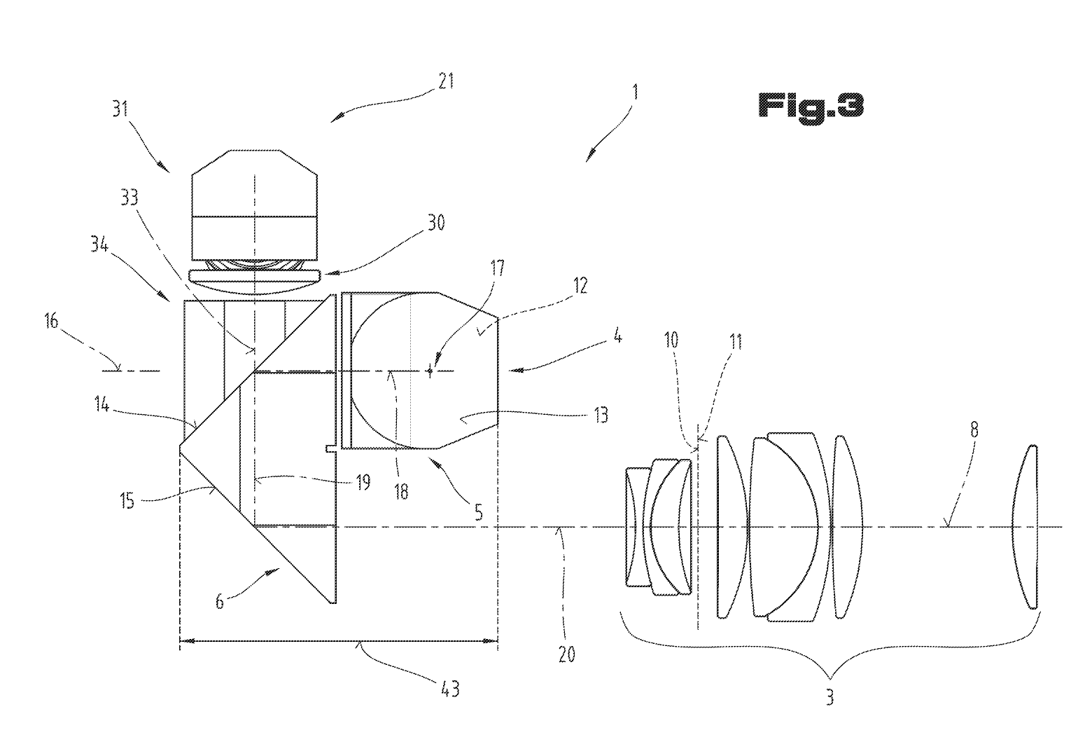

FIG. 3 a cross-section of the prism reversing system with the projection optics and eyepiece illustrated in FIG. 2;

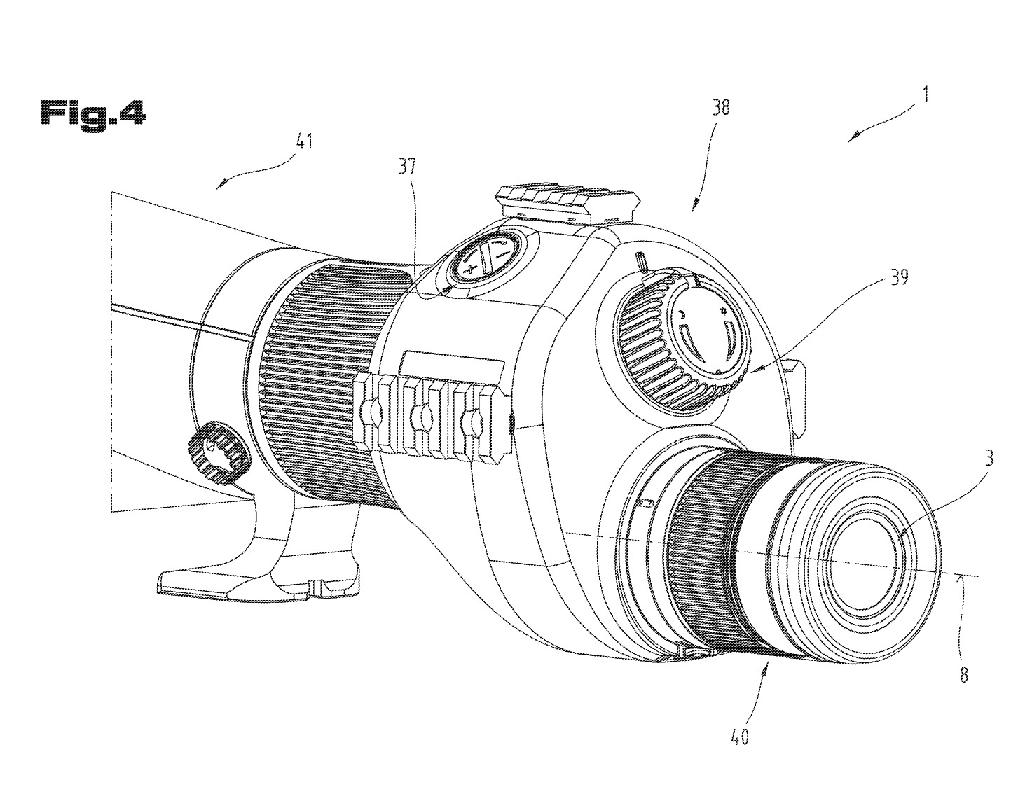

FIG. 4 a perspective view of the eyepiece-end region of the telescope.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates the optical system of a telescope 1 proposed by the invention, in particular a terrestrial telescope.

The telescope 1 comprises an objective lens 2 and an eyepiece 3 and a prism reversing system 4 disposed in between. The prism reversing system 4 in this exemplary embodiment is provided in the form of a Porro prism system of a first type. Accordingly, the prism reversing system 4 comprises a first deflecting prism 5 and a second deflecting prism 6. Providing the prism reversing system 4 in the form of a Porro prism system means that an optical axis 7 of the objective lens 2 is disposed offset from and parallel with an optical axis 8 of the eyepiece 3.

Disposed in the observation beam path of the telescope 1 extending between the objective lens 2 and the eyepiece 3 is a focusing device 9 in the form of a lens positioned between the objective lens 2 and the prism reversing system 4. In this embodiment illustrated as an example, the focusing device 9 is what is known as a Barlow lens.

For the sake of simplicity and to provide a clearer overall view, the optical paths are only symbolically represented by the corresponding main beams in the drawings.

By adjusting the focusing device 9, an image plane 10 of distant objects created by the objective lens can be moved so that it coincides with a focal plane 11 of the eyepiece 3 (FIG. 3).

Due to the fact that the prism reversing system 4 is provided in the form of a Porro prism system having a first and second reflection surface 12, 13 of the first deflecting prism 5 and having a first and second reflection surface 14, 15 of the second deflecting prism 6, the observation beam path of the telescope 1 can be described as a cohesive series of five main beam portions in total. These are a first main beam portion 16 from the objective lens 2 to the first reflection surface 12 of deflecting prism 5, a second main beam portion 17 between the first reflection surface 12 and second reflection surface 13 of deflecting prism 5, a third main beam portion 18 between the second reflection surface 13 of the first deflecting prism 5 and the first reflection surface 14 of the second deflecting prism 6, a fourth main beam portion 19 between the first and second reflection surfaces 14, 15 of the second deflecting prism 6 and, finally, a fifth main beam portion 20 between the second reflection surface 15 of the second deflecting prism 6 and the eyepiece 3. The first, third and fifth main beam portions 16, 18, 20 are oriented parallel with one another whereas the second and fourth main beam portions 17, 19 are oriented at a right angle to the main beam portions 16, 18, 20. The second and fourth main beam portions 17, 19 are likewise oriented at a right angle to one another.

In addition to the described optical elements of the observation beam path, the telescope 1 proposed by the invention additionally comprises separate projection optics 21 with their own optical path in which a mask 22 is disposed. The mask 22 is provided in the form of a negative of a pattern of a reticle, as a result of which a self-illuminating line image of a reticle can be generated by back-lighting by means of a light source 23.

The optical path of the projection optics 21 is linked to the observation beam path of the telescope 1 by a beam splitter so that an image of the mask 22 can be projected into or displayed in the observation beam path. To this end, the projection optics 21 reproduce an image of the mask 22 in the image plane 10 or in the focal plane 11 of the eyepiece 3 (FIG. 3). Through the eyepiece 3, an observer is finally presented with an overlay of an image of the distant objects and a self-illuminating reticle pattern corresponding to a reticle.

The light source 23 of the projection optics 21 is preferably provided in the form of a red light-emitting LED (with a dominant wavelength in the range of 600 nm to 650 nm). Disposed between the light source 23 and the mask 22 are a diffuser lens 24 and an aspheric condenser lens 25, through which the mask 22 is illuminated. The mask 22 is preferably provided in the form of a plane-parallel glass plate coated with chromium, and only the surface areas corresponding to the lines are uncoated so that it is only through these that light is able to penetrate. The light beams penetrating the mask 22 are also reproduced by a projection lens system comprising several lenses 26, 27, 28, 29, 30. Also disposed in the optical path of the projection optics 21 is yet another deflecting prism 31 so that the optical path as a whole comprises a first main beam portion 32 and, having been deflected on the deflecting prism 31, a second main beam portion 33. The optical path of the projection optics 21 therefore has an angled path. The second main beam portion 33 of the optical path of the projection optics 21 is finally transferred into the observation beam path of the telescope 1 with the aid of a coupling prism 34 which acts as a beam splitter together with the second deflecting prism 6.

It has proved to be of advantage if the projection optics 21 are disposed in the telescope 1 so that their first main beam portion 32 and their second main beam portion 33 are respectively disposed in a position oriented perpendicular to the optical axis 7 of the objective lens 2. The transfer of the optical path of the projection optics 21 into the observation beam path of the telescope 1 advantageously takes place at the first reflection surface 14 of the second deflecting prism 6 of the prism reversing system 4. To this end, the projection optics 21 are disposed in such a way that their second main beam portion 33 is oriented parallel or coaxially with the fourth main beam portion 19 running between the first reflection surface 14 and the second reflection surface 15 of the second deflecting prism 6. The light coming from the projection optics 21 enters the second deflecting prism 6 of the Porro prism system through the coupling prism 34, which is joined to the first reflection surface 14 of the second deflecting prism 6 or is cemented to it. To this end, the reflection surface 14 is provided in the form of a beam splitter, provided with a partially transparent coating. This partially transparent coating is such that a major part of the light of the observation beam path is reflected (typically light in the range <600 nm) and the light coming from the LED constituting the light source 23 is able to penetrate.

FIG. 2 illustrates a cross-section of the telescope 1 with a viewing direction parallel with the optical axis 7 of the objective lens 2 and showing details of the projection optics 21. As may be seen from this diagram, some of the optical elements of the projection optics 21 are mechanically retained in a tube 35. The lens group comprising lenses 27, 28, 29 is secured in a carriage 36 which can be adjusted in the axial direction, i.e. in the direction of the main beam portion 32. The carriage 36 with the lenses 27, 28, 29 therefore forms a focusing device of the projection optics 21. With the aid of this focusing device of the projection optics 21, the image of the mask 22 together with the image of a distant object can be sharply reproduced in the same image plane 10 of the objective lens 2 (FIG. 3). The focusing device with the lenses 27, 28, 29 therefore fulfils the function of diopter compensation for the telescope 1. In order to adjust the carriage 36 of the focusing device of the projection optics 21, an adjusting screw 37 is provided, which is actively connected to the carriage 36. To this end, the adjusting screw 37 is disposed on an external face of a housing 38 of the telescope 1 so that the focusing device of the projection optics 21 can be operated and set from the outside. In this example of an embodiment, the adjusting screw 37 is operated via a slot in the adjusting screw 37 in which a coin or screwdriver or similar is able to engage. However, the adjusting screw 37 may also be provided in the form of a rotating knob, enabling a direct manual adjustment.

FIG. 3 illustrates a cross-section of the prism reversing system 4 with the projection optics 21 and eyepiece 3 illustrated in FIG. 2. The light beams of the observation beam path run from the objective lens 2 passing via the first main beam portion 16 and, having been deflected by the two deflecting prisms 5, 6 of the prism reversing system 4, via the fifth main beam portion 20 to the eye-piece 3. The coupling prism 34 of the projection optics 21 is connected to the second deflecting prism 6 at the first reflection surface 14. The reflection surface 14 of the second deflecting prism 6 therefore constitutes the transition region of the optical path of the projection optics 21 to the observation beam path of the telescope 1. In this transition region, which is provided with a partially transparent coating, the reflection surface 14 of the second deflecting prism 6 simultaneously acts as a beam splitter. The light of the light source 23 selectively passes through this beam splitter so that the optical path of the projection optics 21 coming from the second main beam portion 33 can converge with the fourth main beam portion 19 in the second deflecting prism 6. The transition of the optical path of the projection optics 21 for the mask 22 of the reticle is therefore such that the optical path of the projection optics 21 in the transition region at the reflection surface 14 is oriented parallel with and in particular coaxially with the fourth main beam portion 19 in the second deflecting prism 6. Overall, this ensures that the second main beam portion 33 of the projection optics 21 is oriented perpendicular to the optical axis 8 of the eye-piece 3, in other words perpendicular to the longitudinal extension of the telescope 1.

Looking at the overall length of the optical elements in a direction parallel with the optical axis 8 of the eyepiece 3 (or the optical axis 7 of the objective lens 2), it may be seen that an overall length of the unit comprising the prism reversing system 4 and projection optics 21 is essentially limited to a region of an overall length 43 of the prism reversing system 4. The overall length of the unit comprising the prism reversing system 4 and projection optics 21 can therefore be kept relatively short. This makes it possible for the telescope 1 to be made in a modular design with a portion comprising an objective lens 2 on the one hand, a portion comprising the eyepiece 3 on the other hand and a middle part lying in between which contains the optical elements of the prism reversing system 4, projection optics 21 for the mask 22 and the requisite electrical and electrical components.

FIG. 4 is a perspective view illustrating the eyepiece-end region of the telescope 1. Disposed on the outside of the housing 38 is the adjusting screw 37 for the focusing device of the projection optics 21. Also provided on the housing 38 of the telescope 1 is a control button 39 for controlling the light source 23 of the projection optics 21. The light source 23 can be switched on and off by means of the control button 39; however, the control button 39 can also be used to regulate the brightness of the light source 23. Finally, an eyepiece housing 40 incorporating the eyepiece 3 is disposed on the housing 38 of the telescope 1. Based on this embodiment, the eyepiece 3 is a zoom eyepiece (FIG. 3). The focal length of the eyepiece 3 can be continuously varied across a range so that the overall zoom factor of the telescope 1 is also adjustable across a corresponding range. The eyepiece 3 and eyepiece housing 40 are also interchangeable.

The telescope 1 as a whole is of a modular design and the housing 38 forms a middle part to which the eyepiece housing 40 on the one hand and an objective lens tube 41 incorporating the objective lens 2 on the other hand can be interchangeably connected. The housing 38 as such therefore incorporates the prism reversing system 4 coupled with the projection optics 21 for the mask 22 for displaying a reticle image as well as a power source and the requisite electrical devices (not illustrated) for controlling the light source 23 with the aid of the control button 39.

The disposition of the projection optics 21 in an angled arrangement, i.e. with a first main beam portion 32 and a second main beam portion 33 lying tangentially with respect to a passage 42 of the observation beam path enables a compact design of the middle housing 38 to be obtained. In particular, this disposition of the projection optics 21 has an advantage in that the longitudinal extension of the housing 38 relative to the optical axis 7 of the objective lens 2 can be kept short.

The embodiments illustrated as examples represent possible variants of the telescope, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

Furthermore, Individual features or combinations of features from the different embodiments illustrated and described may be construed as independent inventive solutions or solutions proposed by the invention in their own right.

The objective underlying the independent inventive solutions may be found in the description.

For the sake of good order, finally, it should be pointed out that, in order to provide a clearer understanding of the structure of the telescope, it and its constituent parts are illustrated to a certain extent out of scale and/or on an enlarged scale and/or on a reduced scale.

List of reference numbers

| | |
|---|---|
| 1 | Telescope |
| 2 | Objective lens |
| 3 | Eyepiece |
| 4 | Prism reversing system |
| 5 | Deflecting prism |
| 6 | Deflecting prism |
| 7 | Optical axis |
| 8 | Optical axis |
| 9 | Focusing device |
| 10 | Image plane |
| 11 | Focal plane |
| 12 | Reflection surface |
| 13 | Reflection surface |
| 14 | Reflection surface |
| 15 | Reflection surface |
| 16 | Main beam portion |
| 17 | Main beam portion |
| 18 | Main beam portion |
| 19 | Main beam portion |
| 20 | Main beam portion |
| 21 | Projection optics |
| 22 | Mask |
| 23 | Light source |
| 24 | Diffuser lens |
| 25 | Condenser lens |
| 26 | Lens |
| 27 | Lens |
| 28 | Lens |
| 29 | Lens |
| 30 | Lens |
| 31 | Deflecting prism |
| 32 | Main beam portion |
| 33 | Main beam portion |
| 34 | Coupling prism |
| 35 | Tube |
| 36 | Carriage |
| 37 | Adjusting screw |
| 38 | Housing |
| 39 | Control button |
| 40 | Eyepiece housing |
| 41 | Objective lens tube |
| 42 | Passage |
| 43 | Overall length |

1. Telescope (1) comprising an objective lens (2), an eyepiece (3) and a prism reversing system (4) and having an observation beam path running between the objective lens (2) and eyepiece (3) in which the prism reversing system (4) is disposed, and having projection optics (21) with an optical path for reproducing an image of a reticle in a focal plane of the eyepiece (3), the optical path of the projection optics (21) being coupled into the observation beam path by means of a beam splitter, wherein the projection optics (21) comprise a mask (22) and a light source (23), the light source (23) being disposed so as to illuminate the mask (22) from behind.

2. Telescope (1) according to claim 1, wherein the mask (22) has a plane-parallel glass plate with an opaque coating and the glass plate has transparent regions in the form of a negative of a pattern of the reticle.

3. Telescope (1) according to one of the preceding claims, wherein the projection optics (21) comprise a focusing device by means of which the position of the image plane of the reproduction of the pattern of the reticle can be shifted relative to the position of the image plane (10) of the objective lens (2) and relative to the position of the focal plane (11) of the eyepiece (3).

4. Telescope (1) according to one of the preceding claims, wherein a control button (39) is provided as a means of switching the light source (23) on and off and regulating the brightness thereof.

5. Telescope (1) according to one of the preceding claims, wherein the optical path of the projection optics (21) has a first main beam portion (32) and a second main beam portion (33), and the first main beam portion (32) and the second main beam portion (33) are joined to one another by a deflecting prism (31), and the first main beam portion (32) and the second main beam portion (33) are oriented perpendicular to an optical axis (7) of the objective lens (2).

6. Telescope (1) according to one of the preceding claims, wherein the beam splitter is disposed in a transition region between a coupling prism (34) of the projection optics (21) and the prism reversing system (4) of the observation optical path.

7. Telescope (1) according to one of the preceding claims, wherein the coupling prism (34) is cemented to a deflecting prism (5, 6) of the prism reversing system (4) and a partially transparent coating is provided on a boundary surface between the coupling prism (34) and deflecting prism (5, 6) of the prism reversing system (4).

8. Telescope (1) according to one of the preceding claims, wherein the prism reversing system (4) is a Porro prism system of a first type comprising a first deflecting prism (5) and a second deflecting prism (6), and the first deflecting prism (5) is disposed so as to deflect the observation optical path from a first main beam portion (16) to a second main beam portion (17) and from the second main beam portion (17) to a third main beam portion (18), and the second deflecting prism (6) is disposed so as to deflect the observation optical path from the third main beam portion (18) to a fourth main beam portion (19) and from the fourth main beam portion (19) to a fifth main beam portion (20).

9. Telescope (1) according to claim 8, wherein the coupling prism (34) is disposed on a first reflection surface (14) of the second deflecting prism (6), and the second main beam portion (33) of the optical path of the projection optics (21) is directed coaxially with the fourth main beam portion (19) of the observation optical path running through the second deflecting prism (6).

10. Telescope (1) according to claim 8, wherein [as an alternative to the preceding claim] the coupling prism (34) is disposed on a first reflection surface (12) of the first deflecting prism (5), and the second main beam portion (33) of the optical path of the projection optics (21) is directed coaxially with the second main beam portion (19) of the observation optical path running through the first deflecting prism (5).

11. Telescope (1) according to one of the preceding claims, wherein a focusing device (9) is disposed in the observation beam path between the objective lens (2) and prism reversing system (4).

12. Telescope (1) according to one of the preceding claims, wherein the eyepiece (3) comprises a zoom lens system.
